(19) United States
(12) Patent Application Publication
(10) Pub. No.: US 2012/0182510 A1
(43) Pub. Date: Jul. 19, 2012

(54) LIQUID CRYSTAL DISPLAY DEVICE

(75) Inventors: Su Jeong Kim, Seoul (KR); Kichul Shin, Asan-si (KR); Hoon Kim, Ansan-si (KR); Hokil Oh, Asan-si (KR)

(73) Assignee: SAMSUNG ELECTRONICS CO., LTD., Suwon-si (KR)

(21) Appl. No.: 13/184,114

(22) Filed: Jul. 15, 2011

(30) Foreign Application Priority Data
Jul. 16, 2010 (KR) 10-2010-0069254
Jul. 7, 2011 (KR) 10-2011-0067486

(51) Int. Cl. G02F 1/1337; G02F 1/1343

(52) U.S. Cl. 349/130

(57) ABSTRACT

Provided is a display device. The display device includes a first base substrate, a first alignment layer disposed on the first base substrate, a second base substrate, a second alignment layer disposed on the second base substrate, the second alignment layer facing the first alignment layer, a liquid crystal layer disposed between the first alignment layer and the second alignment layer, the liquid crystal layer including liquid crystal molecules, electrodes applying an electric field into the liquid crystal layer. At least one of the first and second alignment layers includes a main alignment layer, a polar side chain connected to the main alignment layer, the polar side chain causing an electrical interaction with the liquid crystal molecules according to the apply of the electrical field, and a non-polar side chain connected to the main alignment layer, the non-polar side chain configured to vertically align the liquid crystal molecules.

### CROSS-REFERENCE TO RELATED APPLICATIONS

This U.S. non-provisional patent application claims priority under 35 U.S.C. §119 of Korean Patent Application No. 10-2011-0067486, filed on Jul. 7, 2011 and Korean Patent Application No. 10-2010-0069254, filed on Jul. 16, 2010, the entire contents of which are hereby incorporated by reference.

### BACKGROUND

The present disclosure herein relates to a liquid crystal display device including an alignment layer for aligning liquid crystal molecules.

In general, liquid crystal display devices may be classified into nematic type liquid crystal display devices, in-plane-switching type liquid crystal devices, and vertical alignment type liquid crystal device.

In the vertical alignment type liquid crystal display devices, liquid crystal molecules are aligned in a predetermined direction in a state where an electric field is not applied. Also, long axes of the liquid crystal molecules are vertically arranged with respect to a surface of a substrate. Thus, a viewing angle and a contrast ratio may be large.

Methods for aligning the liquid crystal molecules in a predetermined direction may include rubbing methods and light alignment methods.

### SUMMARY

The present disclosure provides a display device including an alignment layer for effectively aligning liquid crystal molecules.

Embodiments of the present disclosure provide display devices including: a first base substrate; a first alignment layer disposed on the first base substrate; a second base substrate; a second alignment layer disposed on the second base substrate, the second alignment layer facing the first alignment layer; a liquid crystal layer disposed between the first alignment layer and the second alignment layer, the liquid crystal layer comprising liquid crystal molecules; electrodes applying an electric field into the liquid crystal layer.

At least one of the first and second alignment layers includes: a main alignment layer; a polar side chain connected to the main alignment layer, the polar side chain causing an electrical interaction with the liquid crystal molecules according to the apply of the electrical field; and a non-polar side chain connected to the main alignment layer, the non-polar side chain configured to vertically align the liquid crystal molecules.

The liquid crystal molecules may be a negative type, and the polar side chain is a positive type. The polar side chain may include: a polar functional group; and a connecting group connecting the main alignment layer to the polar functional group. The polar functional group may comprises at least one of materials having following Chemical Formula 1:

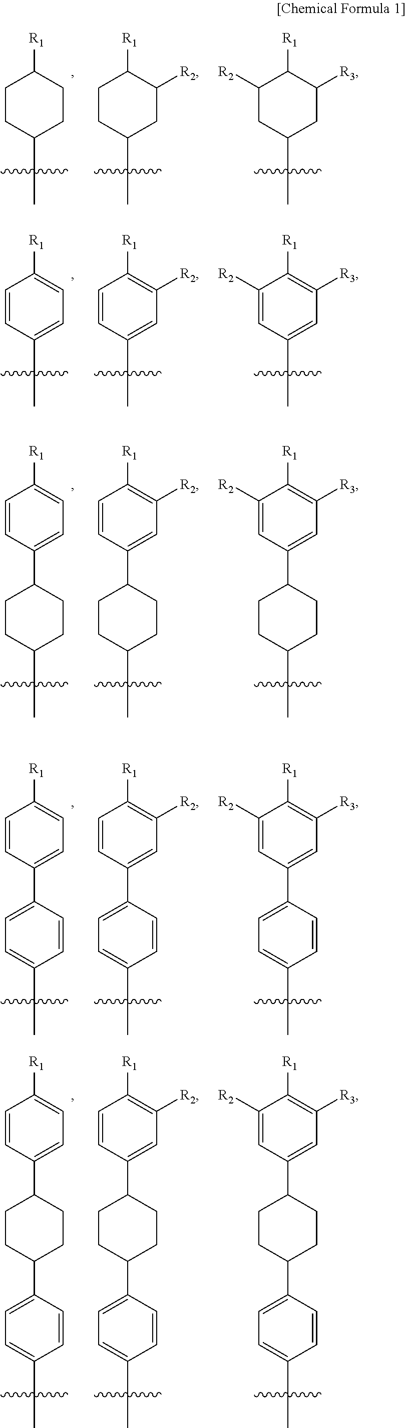

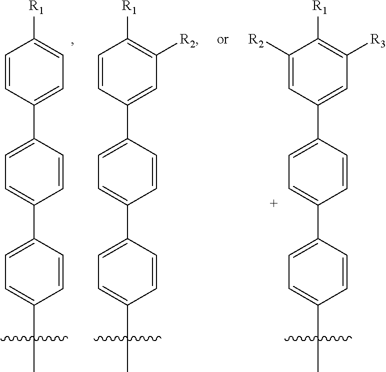

where R1 denotes —F, —CN, —OCH₃, or —NO₂, R₂ denotes —F, —CN, —OCH₃, or —NO₂ denotes —F, —CN, —OCH₃, or —NO₂.

The connecting group may include an oxy-benzoate functional group.

### BRIEF DESCRIPTION OF THE DRAWINGS

The accompanying figures are included to provide a further understanding of the inventive concept, and are incorporated in and constitute a part of this specification. The drawings illustrate exemplary embodiments of the inventive concept and, together with the description, serve to explain principles of the inventive concept. In the figures:

FIG. 1 is a plan view illustrating a portion of a liquid crystal display device having a plurality of pixels according to a first embodiment of the inventive concept;

FIG. 2 is a sectional view of the liquid crystal display device, taken along line I-I′ of FIG. 1;

FIG. 3 is a perspective view of a first alignment layer according to the inventive concept;

FIG. 4 is a sectional view illustrating an interaction between liquid crystal molecules and a polar side chain;

FIG. 5 is a plan view illustrating a layout of a pixel according to a second embodiment of the inventive concept;

FIG. 6 is a sectional view taken along line II-II′ of FIG. 5;

FIG. 7 is a view of a transmittance depending on a voltage in a display device according to an embodiment of the inventive concept;

FIG. 8 is a view of a transmittance depending on a response time of liquid crystal molecules in a display device according to an embodiment of the inventive concept;

FIG. 9 is a photograph illustrating aligned results obtained according to elapsed times in a display device including an existing alignment layer and a display device according to an embodiment of the inventive concept; and

FIG. 10 is a photograph illustrating aligned results obtained according to elapsed times in a display device according to an embodiment of the inventive concept.

### DETAILED DESCRIPTION OF THE EMBODIMENTS

Since the present invention may have diverse modified embodiments, preferred embodiments are illustrated in the drawings and are described in the detailed description of the invention.

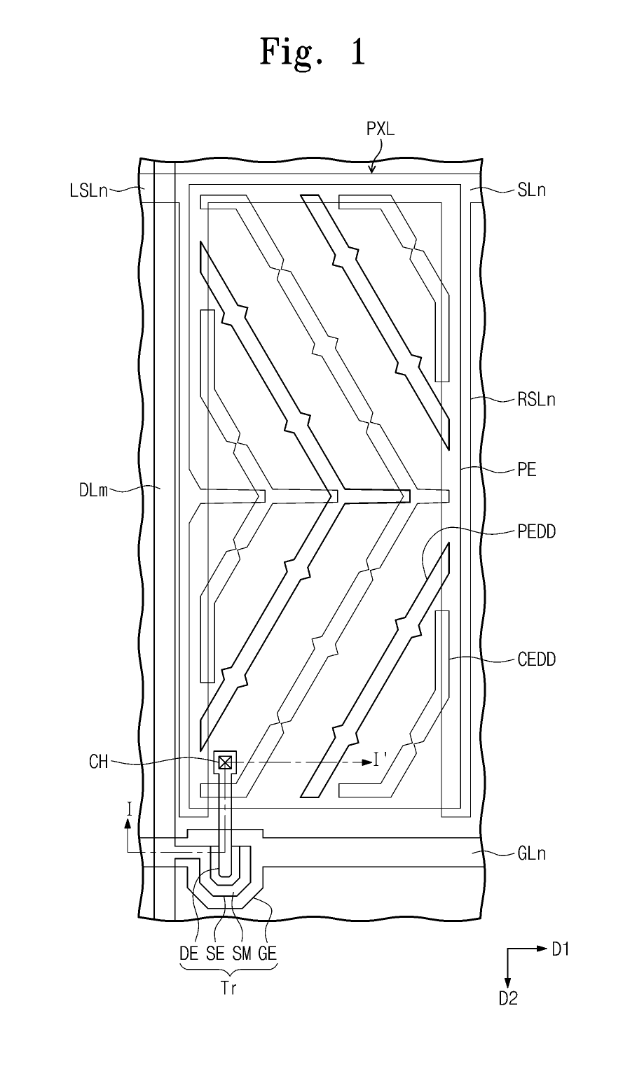

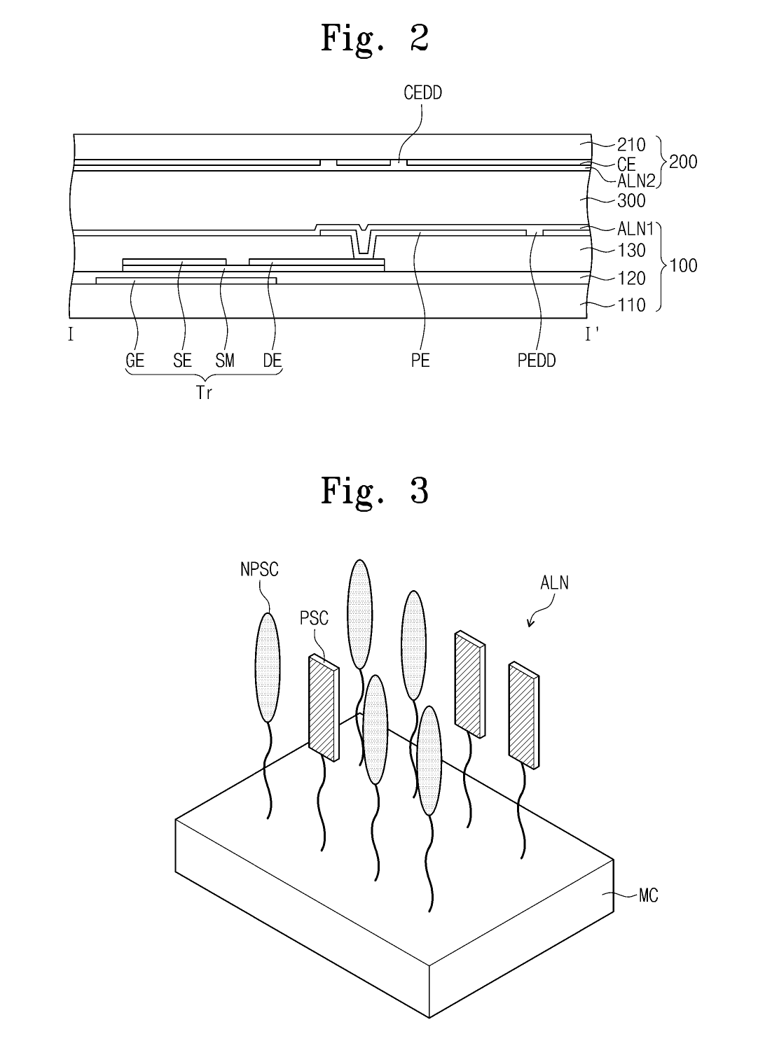

FIG. 1 is a plan view illustrating a portion of a liquid crystal display device having a plurality of pixels according to a first embodiment of the inventive concept. FIG. 2 is a sectional view of the liquid crystal display device, taken along line I-I′ of FIG. 1. Here, since the pixels have the same structure as each other, for convenience of description, one pixel together with gate and data lines adjacent to the one pixel of the pixels is illustrated.

Referring to FIGS. 1 and 2, a display device includes a first substrate 100, a second substrate 200 facing the first substrate 100, and a liquid crystal layer LC disposed between the first substrate 100 and the second substrate 200.

The first substrate 100 includes a first base substrate 110, a plurality of gate lines GLn, a plurality of data lines DLm, a plurality of pixels PXL, and a first alignment layer ALN1.

The first base substrate 110 has an approximately square shape and comprises a transparent insulation material. Here, for convenience of description, one pixel together with an n-th gate line GLn of the plurality of gate lines and an m-th data line DLm is illustrated in FIGS. 1 and 2. However, in the liquid crystal display device according to the first embodiment of the inventive concept, other pixels have the same structure as each other. Hereinafter, the n-th gate line GLn and the m-th data line DLm will be referred to as a gate line and a data line, respectively.

The gate line GLn extends in a first direction D1 on the first base substrate 110. The data line DLm extends in a second direction D2 crossing the first direction D1 between the gate line GLn and a gate insulation layer 120. The gate insulation layer 120 is disposed on an entire surface of the first base substrate 110 to cover the gate line GLn.

Each of the pixels PXL is connected to a corresponding gate line GLn of the gate lines and a corresponding data line DLm of the data lines. The pixel PXL includes a thin film transistor, a pixel electrode PE connected to the thin film transistor, and a storage electrode part. The thin film transistor includes a gate electrode GE, a gate insulation layer 120, a semiconductor pattern SM, a source electrode SE, and a drain electrode DE. The storage electrode part further includes a storage line SLn extending in the first direction D1 and first and second branch electrodes LSLn and RSLn branched from the storage line SLn to extend in the second direction D2.

The gate electrode GE may protrude from the gate line GLn or be disposed on a portion of the gate line GLn.

The gate electrode GE may comprise a metal. The gate electrode GE may comprise one of nickel, chrome, molybdenum, aluminum, titanium, copper, tungsten, and alloys thereof. The gate electrode GE may have a single-layered structure or a multi-layered structure using the metal or metals. For example, the gate electrode GE may have a triple-layered structure in which molybdenum, aluminum, and molybdenum are sequentially stacked with each other or a double-layered structure in which titanium and copper are sequentially stacked with each other. Alternatively, the gate electrode GE may have a single-layered structure formed of an alloy of titanium and copper.

The semiconductor pattern SM is disposed on the gate insulation layer 120. The semiconductor pattern SM is disposed on the gate electrode GE with the gate insulation layer 120 therebetween. The semiconductor pattern SM may partially overlap the gate electrode GE. The semiconductor pattern SM includes an active pattern (not shown) disposed on the gate insulation layer 120 and an ohmic contact layer (not shown) disposed on the active pattern. The active pattern may comprise an amorphous silicon thin film. The ohmic contact layer may be an n+ amorphous silicon thin film. The ohmic contact layer may allow the active pattern to ohmic-contact between the source electrode SE and the drain electrode DE.

The source electrode SE is branched from the data line DLm. The source electrode SE is disposed on the ohmic contact layer to partially overlap the gate electrode GE.

The drain electrode DE is spaced from the source electrode SE with the semiconductor pattern SM therebetween. The drain electrode DE is disposed on the ohmic contact layer to partially overlap the gate electrode GE.

Each of the source electrode SE and the drain electrode DE may comprise one of nickel, chrome, molybdenum, aluminum, titanium, copper, tungsten, and alloys thereof. Each of the source electrode SE and the drain electrode DE may have a single-layered structure or a multi-layered structure using the metal. For example, each of the source electrode SE and the drain electrode DE may have a double-layered structure in which titanium and copper are sequentially stacked with each other. Alternatively, each of the source electrode SE and the drain electrode DE may have a single-layered structure formed of an alloy of titanium and copper.

Thus, when a top surface of the active pattern between the source electrode SE and the drain electrode DE is exposed, a channel part constituting a conductive channel is defined between the source electrode SE and the drain electrode DE according to whether a voltage is applied into the gate electrode GE. The source electrode SE and the drain electrode DE partially overlap the semiconductor layer SM in an area except the channel part defined by spacing the source electrode SE from the drain electrode DE.

The pixel electrode PE is connected to the drain electrode DE with a protection layer 130 therebetween. The pixel electrode PE partially overlaps the storage line SLn and the first and second branch electrodes LSLn and RSLn to form a storage capacitor.

The protection layer 130 covers the source electrode SE, the drain electrode DE, the channel part, and the gate insulation layer 120 and has a contact hole CH for exposing a portion of the drain electrode DE. For example, the protection layer 130 may comprise silicon nitride or silicon oxide.

The pixel electrode. PE is connected to the drain electrode DE through the contact hole CH defined in the protection layer 130.

The pixel electrode PE may include a first domain divider PEDD for dividing the pixel PXL into a plurality of domains. The first domain divider PEDD may be a cutting portion or protrusion formed by patterning the pixel electrode. The cutting portion may be an aperture defined by removing a portion of the pixel electrode PE. The first domain divider PEDD may include a widthwise part disposed in parallel to a first direction D1 or a second direction D2 to bisect a length direction of the pixel PXL and a diagonal line part inclined with respect to the first direction D1 or the second direction D2. The diagonal line part may be substantially line-symmetric with respect to the widthwise part.

The pixel electrode PE comprises a transparent conductive material. The transparent conductive oxide may include indium tin oxide (ITO), indium zinc oxide (IZO), and indium tin zinc oxide (ITZO).

The first alignment layer ALN1 is disposed on the pixel electrode PE to align the liquid crystal molecules of a liquid crystal layer 300 that will be described later.

FIG. 3 is a perspective view of a first alignment layer ALN1 according to the inventive concept.

Referring to FIG. 3, the first alignment layer ALN1 includes a main alignment layer MC, a polar side chain PSC connected to the main alignment MC, and a non-polar side chain (NPSC) connected to the main alignment layer MC.

The main alignment layer MC may be a copolymer which is copolymerized a dianhydride-based monomer and a diamine-based monomer as monomers. For example, the main alignment layer MC may be a polymer in which an alicyclic dianhydride-based monomer as a dianhydride-based monomer and an aromatic diamine-based monomer or an aliphaticring substituted aromatic diamine-based monomer as a diamine-based monomer are copolymerized with each other.

The dianhydride-based monomer may comprise at least one of materials having following Chemical Formula 1.

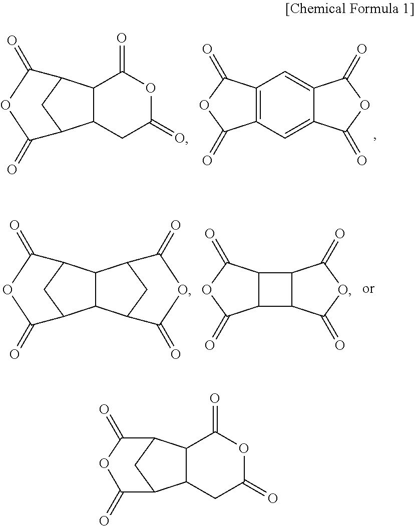

The diamine-based monomer may have following Chemical Formula 2.

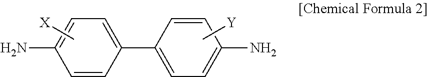

where X denotes a polar side chain PSC or a non-polar side chain NPSC, and Y denotes a polar side chain PSC or a non-polar side chain NPSC. Here, the main alignment layer MC is a polymer except a polymer in which both X and Y of the diamine-based monomer are polar side chains PSCs or non-polar side chains NPSCs. In an embodiment of the inventive concept, the polar side chain PSC may have a molar ratio of about 10 mol % to about 90 mol % of the non-polar side chain NPSC. In another embodiment of the inventive concept, the polar side chain PSC may have a molar ratio of about 40 mol % to about 60 mol % of the non-polar side chain NPSC.

The non-polar side chain NPSC includes an alkyl group for vertically aligning the liquid crystal molecules of the liquid crystal layer 300 and shows non-polar characteristic except a portion where the non-polar side chain NPSC is connected to the main alignment layer MC. For example, the non-polar side chain NPSC may include at least one of an alkoxy group including an aliphatic alkyl group having 1 to 25 carbon atoms, a cholesteric group, an alicyclic group including an aliphatic alkyl group having 1 to 10 carbon atoms, and an aromatic group including the aliphatic alkyl group having 1 to 10 carbon atoms.

The aliphatic alkyl group may have a structural formula of

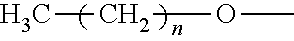

(where n is a natural number of 1 to 25). The alicyclic group may have a structural formula of

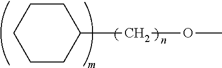

(where m is a natural number of 1 to 5 and n is a natural number of 1 to 10). The aromatic group may have a structural formula of

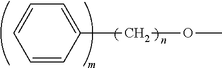

(where, m is a natural number of 1 to 5 and n is a natural number of 1 to 10).

The polar side chain PSC includes a polar functional group and a connecting group connecting the main alignment layer MC to the polar functional group.

The polar functional group is a functional group having a dipole. The polar functional group may comprise at least one of materials having following Chemical Formula 3. In following structural formula, R1 denotes —F, —CN, —OCH₃, or —NO₂ denotes —F, —CN, —OCH₃, or —NO₂, and R3 denotes —F, —CN, —OCH₃, or —NO₂.

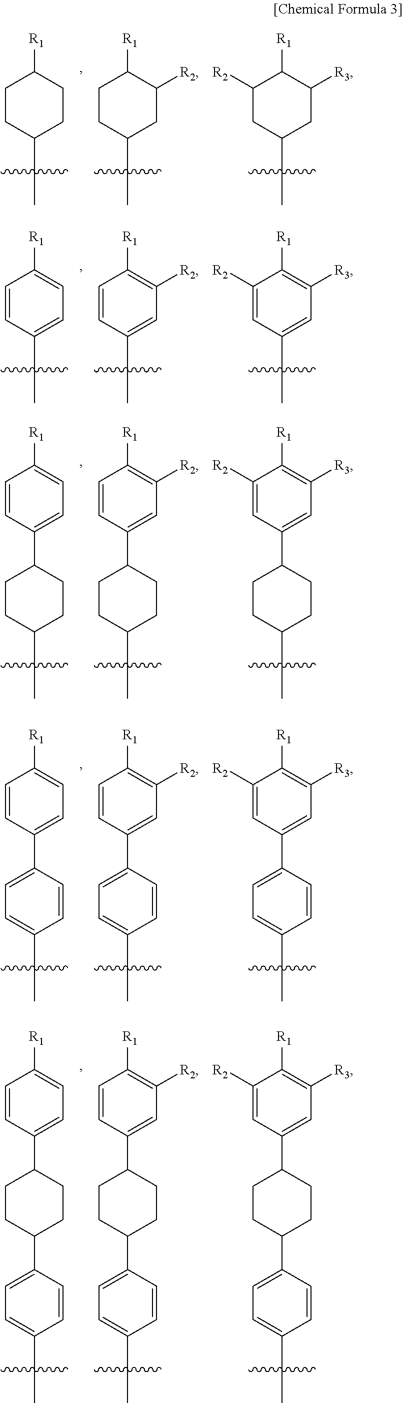

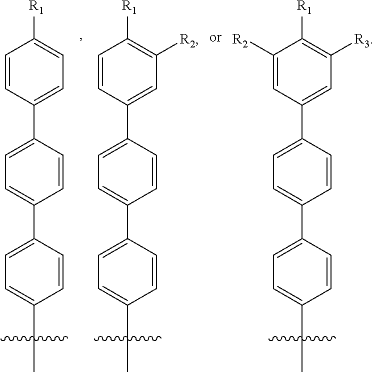

The connecting group may be any group which can connect the main alignment layer MC to the polar functional group. The present disclosure is not limited thereto. For example, the connecting group may be an oxy-benzoate functional group having following Chemical Formula 4.

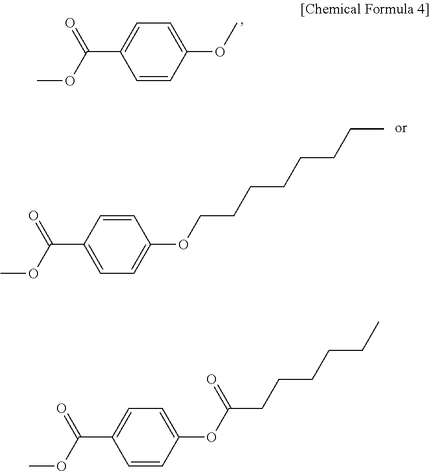

The second substrate 200 includes a second base substrate 210, a common electrode CE, and a second alignment layer ALN2.

The common electrode CE is disposed on the second base substrate 210 to form an electric field together with the pixel electrode PE, thereby operating the liquid crystal layer 300. The common electrode CE may comprise a transparent conductive material. For example, the common electrode CE may comprise conductive metal oxide such as indium tin oxide (ITO), indium zinc oxide (IZO), or indium tin zinc oxide (ITZO).

The pixel electrode PE may include a second domain divider CEDD for dividing the pixel PXL into a plurality of domains. The second domain divider CEDD may be a cutting portion or protrusion formed by patterning the common electrode CE. The cutting portion may be an aperture defined by removing a portion of the common electrode CE. The second domain divider CEDD may include a widthwise part and/or a lengthwise part disposed parallelly along a first direction D1 or a second direction D2 to bisect a length direction of the pixel PXL and a diagonal line part inclined with respect to the first direction D1 or the second direction D2. The diagonal line part may be substantially line-symmetric with respect to the widthwise part.

The widthwise part of the first domain divider PEDD and the widthwise part of the second domain divider CEDD may be disposed on the substantially same line. The diagonal line part of the first domain divider PEDD and the diagonal line part of the second domain divider CEDD may be parallelly arranged in the same direction. Also, the diagonal line part of the first domain divider PEDD and the diagonal line part of the second domain divider CEDD may be alternately disposed.

The second alignment layer ALN2 is disposed on the common electrode CE. The second alignment layer ALN2 is disposed on the common electrode CE to align the liquid crystal molecules of the liquid crystal layer.

Referring to FIG. 2, the first alignment layer ALN1, the second alignment layer ALN2 includes a main alignment layer MC, a polar side chain PSC connected to the main alignment MC, and a non-polar side chain (NPSC) connected to the main alignment layer MC.

The main alignment layer MC may be a copolymer in which has dianhydride-based monomer and a diamine-based monomer as monomers. For example, the main alignment layer MC may be a polymer in which an alicyclic dianhydride-based monomer as a dianhydride-based monomer and an aromatic diamine-based monomer or an aliphaticring substituted aromatic diamine-based monomer as a diamine-based monomer are copolymerized with each other.

The dianhydride-based monomer may comprise at least one of materials having Chemical Formula 1 above.

The diamine-based monomer may have Chemical Formula 2 above.

X denotes a polar side chain PSC or a non-polar side chain NPSC, and Y denotes a polar side chain PSC or a non-polar side chain NPSC. Here, the main alignment layer MC may be a polymer except a polymer in which both X and Y of the diamine-based monomer are polar side chains PSCs or non-polar side chains NPSCs. In an embodiment of the inventive concept, the polar side chain PSC may have a molar ratio of about 10 mol % to about 80 mol % of the non-polar side chain NPSC.

The non-polar side chain NPSC includes an alkyl group for vertically aligning the liquid crystal molecules of the liquid crystal layer 300 and shows non-polar characteristic except a portion where the non-polar side chain NPSC is connected to the main alignment layer MC. For example, the non-polar side chain NPSC may include at least one of an alkoxy group including an aliphatic alkyl group having 1 to 25 carbon atoms, a cholesteric group, an alicyclic group including an aliphatic alkyl group having 1 to 10 carbon atoms, and an aromatic group including the aliphatic alkyl group having 1 to 10 carbon atoms.

The aliphatic alkyl group may have a structural formula of

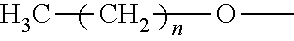

(where n is a natural number of 1 to 25). The alicyclic group may have a structural formula of

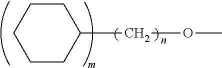

(where m is a natural number of 1 to 5 and n is a natural number of 1 to 10). The aromatic group may have a structural formula of

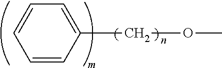

(where, m is a natural number of 1 to 5 and n is a natural number of 1 to 10).

The polar side chain PSC includes a polar functional group and a connecting group connecting the main alignment layer MC to the polar functional group.

The polar functional group is a functional group having a dipole. The polar functional group may comprise at least one of materials having following Chemical Formula 3. In following structural formula, R1 denotes —F, —CN, —OCH₃, or —NO₂ denotes —F, —CN, —OCH₃, or —NO₂, and R3 denotes —F, —CN, —OCH₃, or —NO₂. The connecting group may be any group which can connect the main alignment layer MC to the polar functional group. The present disclosure is not limited thereto. For example, the connecting group may be an oxy-benzoate functional group having Chemical Formula 4 above.

Here, the second alignment layer ALN2 may comprise the same material as that of the first alignment layer ALN1 or comprise a material different from that of the first alignment layer ALN1.

As described above, according to an embodiment of the inventive concept, the first alignment layer ALN1, the second alignment layer ALN2 includes a main alignment layer MC, a polar side chain PSC connected to the main alignment MC, and a non-polar side chain (NPSC) connected to the main alignment layer MC. However, the present disclosure is not limited thereto. For example, according to another embodiment of the present invention, only one of the first alignment layer ALN1 and the second alignment layer ALN2 may includes the main alignment layer MC, the polar side chain PSC connected to the main alignment MC, and the non-polar side chain (NPSC) connected to the main alignment layer MC. The other one of the first alignment layer ALN1 and the second alignment layer ALN2 may be an existing alignment layer that is previously well-known.

The liquid crystal layer 300 including the liquid crystal molecules is disposed between the first substrate 100 and the second substrate 200. The liquid crystal layer 300 may include negative type liquid crystal molecules which are used in a vertical alignment mode.

In the display device, when a gate signal is applied into the gate line GLn, the thin film transistor Tr is turned on. Thus, the data signal applied into the data line DLm is applied into the pixel electrode PE through the thin film transistor Tr. When the thin film transistor Tr is turned on to apply the data signal into the pixel electrode PE, an electric field is formed between the pixel electrode PE and the common electrode CE. The liquid crystal molecules are operated by the electric field generated by a difference of the voltages applied into the common electrode CE and the pixel electrode PE. Thus, an amount of light transmitting the liquid crystal layer 300 is varied to display an image.

Here, the liquid crystal molecules are arranged in a certain direction by the interaction between the first and second alignment layers ALN1 and ALN2 according to whether the electric field is applied. In detail, the liquid crystal molecules are easily arranged in a certain direction by the electrical interaction with the polar side chain PSC.

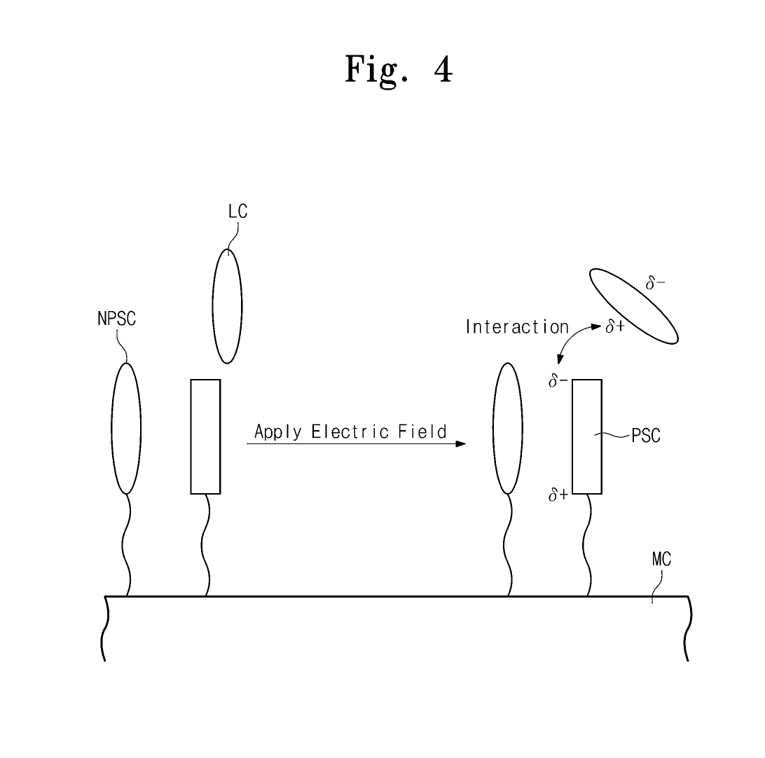

FIG. 4 is a sectional view illustrating an interaction between liquid crystal molecules LC and the polar side chain PSC. For example, FIG. 4 illustrates an interaction between liquid crystal molecules having a negative type (Δε<0) and an alignment layer including a polar side chain PSC having a positive type (Δε>0). Here, for convenience of description, first and/or second alignment layer(s) ALN1 and/or ALN2 are referred to as an alignment layer ALN.

Referring to FIG. 4, when an electric filed is not applied to the alignment layer ALN and the liquid crystal molecules LC, the liquid crystal molecules LC are aligned in a substantially vertical direction with respect to a surface of the alignment layer ALN by the non-polar side chain NPSC connected to the main alignment layer MC. When an electric field is applied to the alignment layer ALN and the liquid crystal molecules LC, the liquid crystal molecules LC are arranged in a predetermined direction in response to the electric field. Here, the liquid crystal molecules LC are easily arranged in the predetermined direction by a dipole-dipole interaction between the polar side chain PSC and the liquid crystal molecules LC. Thereafter, when the electric field is not applied, the liquid crystal molecules LC are vertically aligned again by an effect of the non-polar side chain NPSC.

Thus, the response time of the liquid crystal molecules may be quicker in the pixel electrode and the common electrode when compared to an existing display device. Also, the liquid crystal molecules may be operated with a low operation voltage. As a result, when viewed in plan view, even though the shortest distance between a diagonal line part of the first domain divider and a diagonal line part of the second domain divider is greater than that in the existing display device, the liquid crystal molecules may be easily operated. When the shortest distance (i.e., a distance between the first domain divider and the second domain divider) becomes longer, an aperture ratio and transmittance of each pixel may be improved.

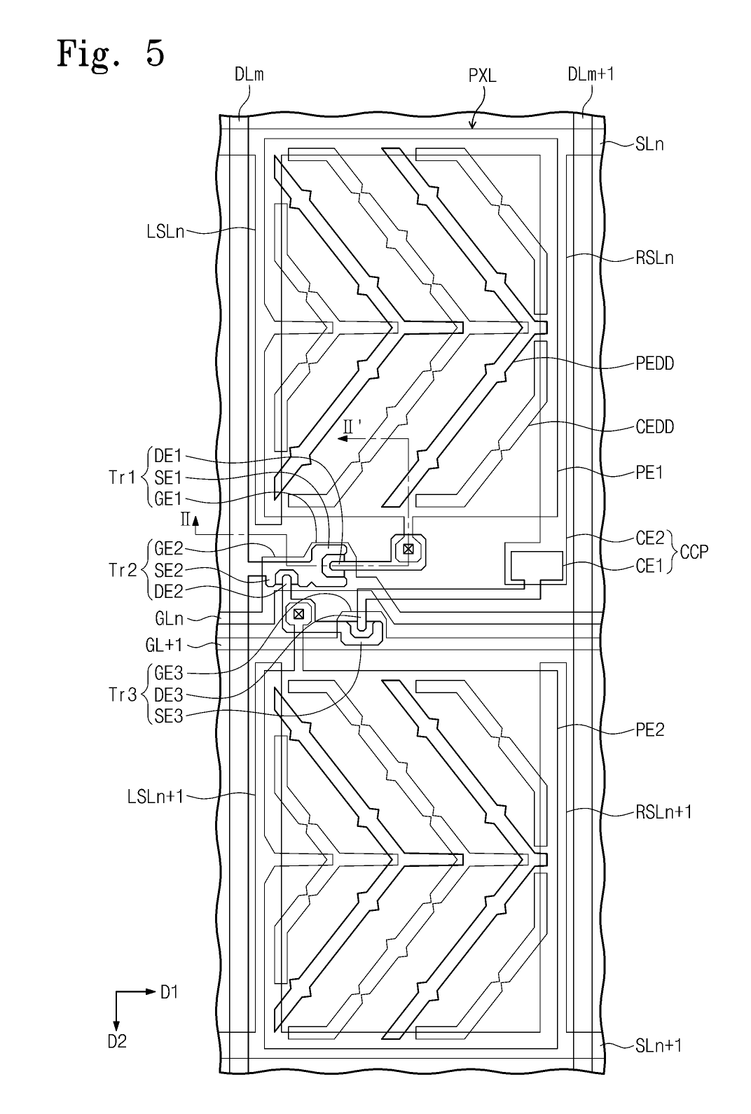

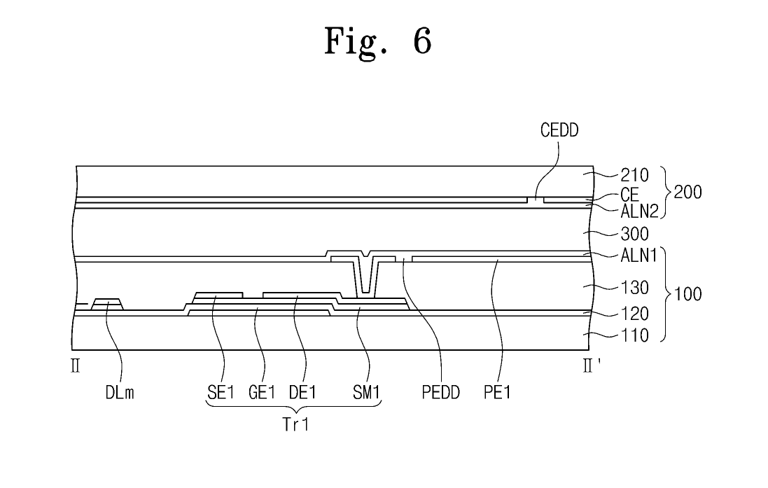

The display device according to the current embodiment of the inventive concept may have various pixel structures. FIG. 5 is a plan view illustrating a layout of a pixel according to a second embodiment of the inventive concept. FIG. 6 is a sectional view taken along line II-II′ of FIG. 5. Although a following layout of a pixel is described as an example, the present disclosure is not limited thereto. A pixel according to another embodiment of the inventive concept may have a layout different from that of the pixel illustrated in FIGS. 5 and 6. For example, according to another embodiment of the inventive concept, one gate line and one data line may be connected to one pixel. According to further another embodiment of the inventive concept, one gate lien and two data lines may be connected to one pixel.

Referring to FIGS. 5 and 6, a first substrate 100 includes a first base substrate 110, a plurality of gate lines disposed on the first base substrate 110, a plurality of data lines, a plurality of pixels PXL connected to the gate lines and the data lines, and a first alignment layer ALN1 disposed on the pixels PXL.

For convenience of description, one pixel together with an n-th gate line GLn and an (n+1)th gate line GLn+1 among the plurality of gate liens and an m-th data line DLm and an (m+1)th data line DLm+1 among the plurality of data lines is illustrated in FIGS. 5 and 6. However, in the liquid crystal display device according to the second embodiment of the inventive concept, other pixels have the same structure as each other. Hereinafter, the n-th gate line GLn and the (n+1)th gate line GLn+1 are called a first gate line and a second gate line, respectively. Also, the m-th data line DLm and the (m+1) data line DLm+1 are called a first data line and a second data line, respectively.

The first and second gate lines GLn and GLn+1 parallelly extend in a first direction D1 on the first base substrate 110. The first and second data lines DLm and DLm+1 parallely extend in a second direction D2 crossing the first direction D1 with a gate insulation layer 120 therebetween.

Each of the pixels PXL includes a first sub pixel and a second sub pixel. The first sub pixel includes a first thin film transistor Tr1, a first sub pixel electrode PE1, and a first storage electrode part. The second sub pixel includes a second thin film transistor Tr2, a second storage electrode part, a third thin film transistor Tr3, a second sub pixel electrode PE2, and a coupling capacitor electrode CE1.

The first thin film transistor Tr1 of the first sub pixel is connected to the first data line DLm and the first gate line GLn.

A first gate electrode GE1 of the first thin film transistor Tr1 is branched from the first gate line GLn, and a first source electrode SE1 is branched from the first data line DLm. A first drain electrode DE1 of the first thin film transistor Tr1 is electrically connected to the first sub pixel electrode PE1.

The first storage electrode part further includes a first storage line SLn extending in the first direction D1 and first and second branch electrodes LSLn and RSLn branched from the first storage line SLn to extend in the second direction D2.

The first pixel electrode PE1 partially overlaps the first storage line SLn and the first and second branch electrodes LSLn and RSLn to form the first storage capacitor.

A second gate electrode GE2 of the second thin film transistor Tr2 is branched from the first gate line GLn, and a second source electrode SE2 is branched from the first data line DLm. A second drain electrode DE2 of the second thin film transistor Tr2 is electrically connected to the second sub pixel electrode PE2.

The second storage electrode part further includes a second storage line SLn+1 extending in the second direction D2 and third and fourth branch electrodes LSLn+1 and RSLn+1 branched from the second storage line SLn+1 to extend in the second direction D2.

The first pixel electrode PE1 and the second sub pixel electrode PE2 may include a first domain divider PEDD for dividing the first sub pixel electrode PE1 into a plurality of domains. The first domain divider PEDD may be a cutting portion or protrusion formed by pattering the first sub pixel electrode PE1 and the second sub pixel electrode PE2. The cutting portion may be an aperture defined by removing portions of the first sub pixel electrode PE1 and the second sub pixel electrode PE2. The first domain divider PEDD may include a widthwise part parallelly disposed along the first direction D1 or the second direction D2 and a diagonal line part inclined with respect to the first direction D1 or the second direction D2. The diagonal line part may be substantially line-symmetric with respect to the widthwise part.

A third gate electrode GE3 of the third thin film transistor Tr3 is branched from the second gate line GLn+1, a third source electrode SE3 extends from the second drain electrode DE2, and a third drain electrode DE3 is connected to the coupling capacitor electrode CE1. The coupling capacitor electrode CE1 extends from the second branch electrode RSLn. Here, the coupling capacitor electrode CE1 and a coupling capacitor CCP constitute an opposite electrode CE2. However, the present disclosure is not limited to the above-described structure of the coupling capacitor CCP.

The first alignment layer ALN1 is disposed on the first base substrate 10 on which the pixels PXL are disposed.

The second substrate 200 includes a second base substrate 210, a common electrode CE, and a second alignment layer ALN2.

The common electrode CE and the second alignment layer ALN2 are sequentially disposed on the second base substrate 210.

The pixel electrode PE may include a second domain divider CEDD for dividing the common electrode CE into a plurality of domains. The second domain divider CEDD may be a cutting portion or protrusion formed by patterning the common electrode CE. The cutting portion may be an aperture defined by removing a portion of the common electrode CE. The first domain divider PEDD may include a widthwise part and/or a lengthwise part parallelly disposed along the first direction D1 or the second direction D2 and a diagonal line part inclined with respect to the first direction D1 or the second direction D2. The diagonal line part may be substantially line-symmetric with respect to the widthwise part.

The widthwise part of the first domain divider PEDD and the widthwise part of the second domain divider CEDD may be disposed on the substantially same line. The diagonal line part of the first domain divider PEDD and the diagonal line part of the second domain divider CEDD may be parallelly arranged in the same direction. Also, the diagonal line part of the first domain divider PEDD and the diagonal line part of the second domain divider CEDD may be alternately disposed.

The second alignment layer ALN2 is disposed on the second base substrate 210 on which the common electrode 211 is disposed.

The liquid crystal layer 30 is disposed between the first alignment layer ALN1 and the second alignment ALN2. The liquid crystal layer 300 may be a liquid crystal layer vertically aligned with respect to the first alignment layer ALN1 and the second alignment layer ALN2 when an electric field is not applied into the pixel electrode PE and the common electrode CE.

The first alignment layer ALN1 and/or the second alignment layer ALN2 may be formed through the same method as the first alignment layers according to the first embodiment.

FIG. 5 is an equivalent circuit diagram of the pixel according to the second embodiment of the inventive concept. Referring to FIG. 5, each of the pixels PX includes a first sub pixel SPX1 and a second sub pixel SPX2. The first sub pixel SPX1 includes a first thin film transistor Tr1, a first liquid crystal capacitor Clc1, and a first storage capacitor Cst1. The second sub pixel SPX2 includes a second thin film transistor Tr2, a second liquid crystal capacitor Clc2, a second storage capacitor Cst2, a third thin film transistor Tr3, and a coupling capacitor CCP. The first and second sub pixels SPX1 and SPX2 are disposed between two data lines (hereinafter, referred to as a first data line DLm and a second data line DLm+1) adjacent to each other. Also, the first thin film transistor Tr1 of the first sub pixel SPX1 is connected to the first data line DLm and a first gate line GLn. The second thin film transistor Tr2 of the second sub pixel SPX2 is connected to the first data line DLm and a first gate line GLn. Specifically, the first thin film transistor Tr1 includes a first source electrode connected to the first data line DLm, a first gate electrode connected to the first gate line GLn, and a first drain electrode connected to the first liquid crystal capacitor Clc1. The first storage capacitor Cst1 is disposed between the first drain electrode and the first storage line SLn and connected to the first liquid crystal capacitor Clc1 in parallel. The second thin film transistor Tr2 includes a second source electrode connected to the first data line DLm, a second gate electrode connected to the first gate line GLn, and a second drain electrode connected to the second liquid crystal capacitor Clc2. The second thin film transistor Tr2 includes a second source electrode connected to the first data line DLm, a second gate electrode connected to the first gate line GLn, and a second drain electrode connected to the second liquid crystal capacitor Clc2. The second storage capacitor Cst2 is disposed between the second drain electrode and the second storage line SLn+1 and connected to the second liquid crystal capacitor Clc2 in parallel.

When a first gate signal is applied into the first gate line GLn, the first and second thin film transistors Tr1 and Tr2 are turned on at the same time. A data voltage applied into the first data line DLm is applied into the first and second liquid crystal capacitors Clc1 and Clc2 through the first and second thin film transistors Tr1 and Tr2 which are turned on. Thus, a pixel voltage having the same intensity is charged into the first and second liquid crystal capacitors Clc1 and Clc2 in a section in which the first gate signal is high.

The third thin film transistor Tr3 includes a third source electrode connected to the second drain electrode of the second thin film transistor Tr2, a third gate electrode connected to the second gate line GLn+1, and a third drain electrode connected to the coupling capacitor CCP. The second gate line GLn+1 receives a second gate signal which rises after the first gate signal falls. When the third thin film transistor Tr3 is turned on in response to the second gate signal, voltage distribution occurs between the second liquid crystal capacitor Clc2 and the coupling capacitor CCP. As a result, the pixel voltage charged in the second liquid crystal capacitor Clc2 is down. An intensity at which the pixel voltage is down may be varied according to a charging rate of the coupling capacitor CCP. Thus, after the second gate signal is generated, a first pixel voltage is charged into the first liquid crystal capacitor Clc1. Also, a second pixel voltage having an intensity less than that of the first pixel voltage may be charged into the second liquid crystal capacitor Clc2. Thus, liquid crystal molecules disposed in a region corresponding to that of the first sub pixel electrode PE1 are inclined at an angle different from that of the liquid crystal molecules disposed in a region corresponding to that of the second sub pixel electrode PE2 because electric fields having intensities different from each other are respectively applied into the liquid crystal molecules disposed in the two regions. Thus, the liquid crystal molecules disposed corresponding to the two regions have inclined angles different from each other. Therefore, since phase delay of the light is compensated, visibility may be improved. That is to say, the liquid crystal molecules within the two regions may form a plurality of domains having vertical alignment degrees different from each other, thereby improving the visibility. In a display device according to the second embodiment of the inventive concept, since the display device has the advantages of the display device according to the first embodiment as well as the improved visibility, an image quality of the display device may be improved.

In the second embodiment of the inventive concept, although each of the pixels PXL is connected to two gate lines GLn and GLn+1 and one data lines DLm, the present disclosure is not limited thereto

For example, each of the pixels PXL may be connected to one gate line and two data lines. Alternatively, each of the pixels may have two pixel electrodes, like the second embodiment, but is not limited thereto. For example, each of the pixels may have three or more pixel electrodes. The number of pixel electrodes may be varied according to a design of each of the pixels. For example, each of the pixels may be divided into a plurality of sub pixels. Also, at least one sub pixel electrode may correspond to each of the sub pixels.

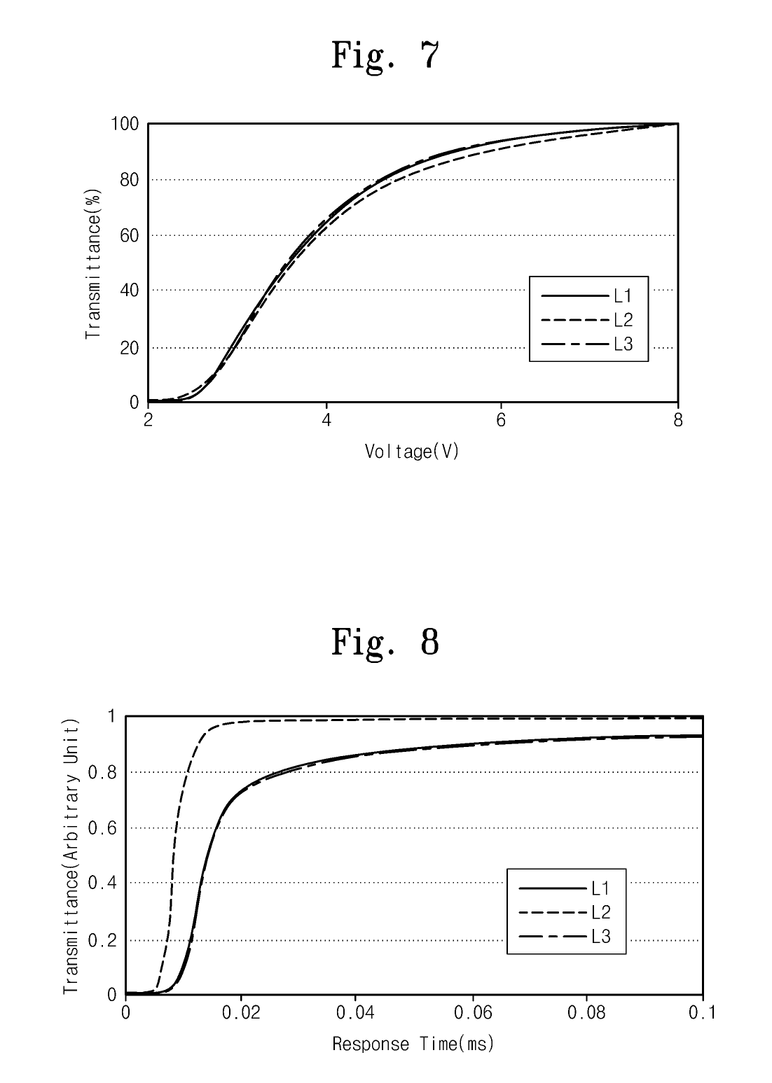

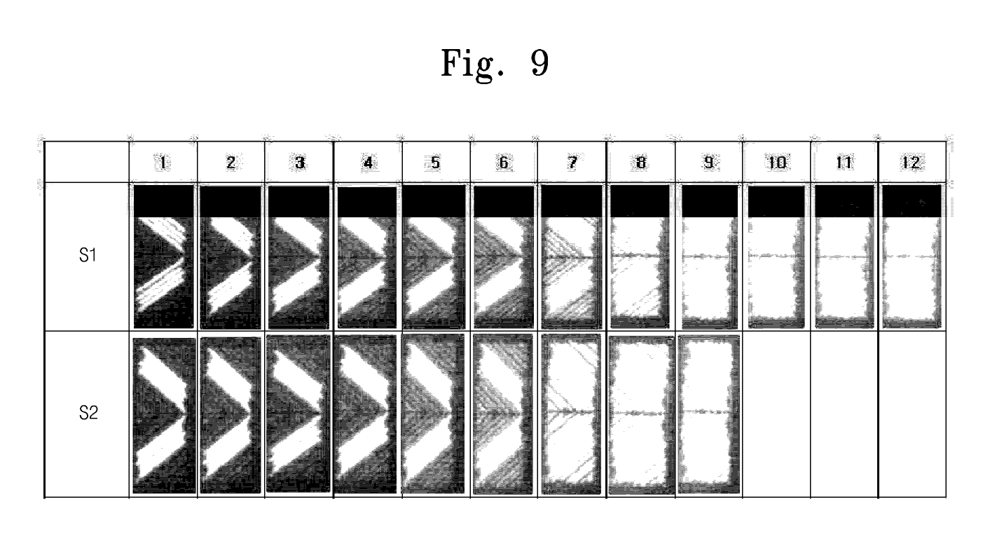

FIG. 7 is a view of a transmittance depending on a voltage in a display device according to an embodiment of the inventive concept. FIG. 8 is a view of a transmittance depending on a response time of liquid crystal molecules in a display device according to an embodiment of the inventive concept. In FIGS. 7 and 8, a line L1 shows a transmittance of a display device using an alignment layer according to a related art. A line L2 shows a transmittance of a display device including first and second alignment layers having negative type liquid crystal molecules and a positive type polar side chain. A line L3 shows a transmittance of a display device including first and second alignment layers having positive liquid crystal molecules and a negative polar side chain. In the display devices used for obtaining the lines L1 to L3, the display devices have the same structure as each other except those of the alignment layers.

Referring to FIGS. 7 and 8, the lines L1 to L3 show the same transmittance as each other. However, in the transmittance according to response times, the line L1 has a relatively less response time and a relatively high transmittance when compared to those of line L2. In the graph, in case of the display device including the alignment layer having the negative type liquid crystal molecules and the positive type polar side chain, it is confirmed that a response time and transmittance of the liquid crystal molecules may be improved.

FIG. 9 is a photograph illustrating aligned results obtained according to the elapsed time in a display device including an existing alignment layer and a display device according to an embodiment of the inventive concept. Referring to FIG. 9, a photograph S1 shows an alignment state in a display device using an alignment layer according to the related art. A photograph S2 shows an alignment state in a display device including first and second alignment layers having negative type liquid crystal molecules and a positive type polar side chain. The photographs of FIG. 9 are photographed at about 1,000 frames per a unit time using a high speed CCD. In the display devices used for the photographs S1 and S2, the display devices have the same structure as each other except those of the alignment layers.

Referring to the photographs of FIG. 9, the alignment is completed at only nine frames in the display device including the first and second alignment layers, but with twelve frames in the display device including the existing alignment layer. Here, in the display device including the existing alignment layer and the display device including the first and second alignment layers according to the inventive concept, Table 1 below shows results obtained according to response time waveforms.

TABLE 1

| | Rising | Falling |
|---|---|---|
| S1 | 14.8 ms | 3.95 ms |
| S2 | 8.3 ms | 4.05 ms |

Referring to Table 1, the display device according to an embodiment of the inventive concept has a response time quicker by about 6.5 ms than that of an existing display device.

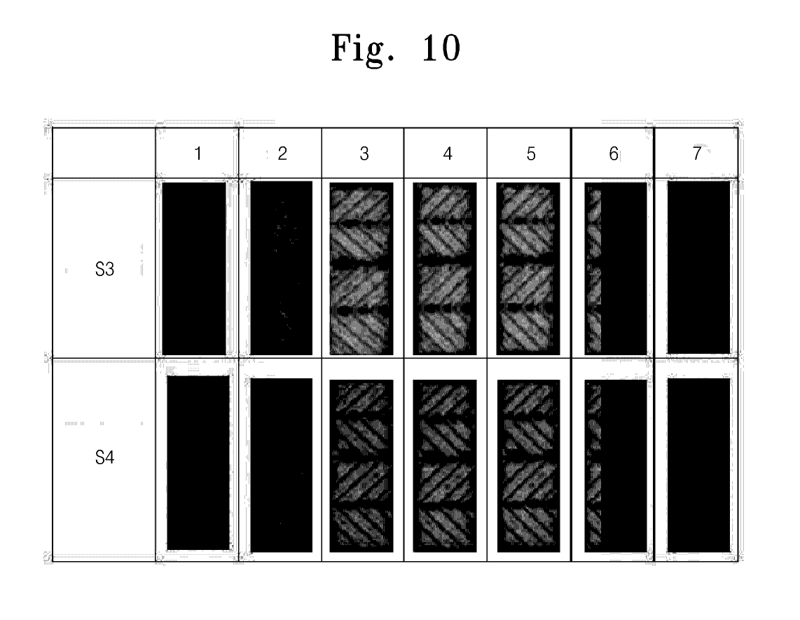

FIG. 10 is a photograph illustrating aligned results obtained according to elapsed times in a display device according to an embodiment of the inventive concept. A photograph S3 shows an alignment state in case where an existing alignment layer is used as a first alignment layer and an alignment layer having a positive type polar side chain is used as a second alignment layer. Also, a photograph S4 shows an alignment state in case where an alignment layer having a positive type polar side chain is used as a first alignment layer and an existing alignment layer is used as a second alignment layer. The photographs of FIG. 10 are photographed at about 1,000 frames per a unit time using a high speed CCD. In the display devices used for the photographs S3 and S4, the display devices have the same structure as each other except those of the alignment layers.

Referring to the photographs of FIG. 10, the alignment is completed at only seven frames in the photographs S3 and S4. Here, although not shown, in a display device having the same alignment as those of the photographs S3 and S4 and including existing alignment layers as first and second alignment layers, the alignment is completed at twelve frames. In detail, the display device including the existing alignment layer has an alignment completion time of about 0.15 seconds. Also, the display device having the alignment state such as the photographs S3 and S4 has an alignment completion time of about 0.03 seconds. Here, a display device (not shown) which has the same alignment state as those of the photographs S3 and S4 and includes alignment layers having positive type polar side chains has an alignment completion time of about 0.01 seconds, i.e., the fastest alignment completion time.

Table 2 below shows an improved degree of a response time with respect to existing display devices having the same structure as each other in the display device having the structure according to the first embodiment of the inventive concept and the display device having the structure according to the second embodiment of the inventive concept. Referring to Table 2, it is confirmed that the response time are significantly improved in both display devices, in which the polar side chain and non-polar side chain are used, according to the first and second embodiments. Also, in the first and second embodiments, it is seen that a kind of main alignment layer may be changed or the polar or non-polar side chain may be exchanged to adjust the response time.

TABLE 2

| | | Response time | | |
|---|---|---|---|---|
| Test | Vertical | First | Second | |
| order | alignment | embodiment | embodiment | Note |
| 1 | Good | 67% | 74% | Molar ratio of polar |
| | | | | side chain to non-polar |
| | | | | side chain is 50:50 |
| 2 | Good | 46% | 76% | Molar ratio of polar |
| | | | | side chain to non-polar |
| | | | | side chain is 40:60 |
| 3 | Good | 68% | * | Molar ratio of polar |
| | | | | side chain to non-polar |
| | | | | side chain is 50:50, |
| | | | | Main alignment layer |
| | | | | change |

According to the embodiments of the inventive concept, the alignment layer having the negative type liquid crystal molecules and the positive type polar side chain may be adopted to the display device to improve the response time of the liquid crystal molecules according to the electric field. Therefore, in the vertical alignment display device, a distance between the domain dividers may be widened to improve the transmittance of the display device.

The above-disclosed subject matter is to be considered illustrative and not restrictive, and the appended claims are intended to cover all such modifications, enhancements, and other embodiments, which fall within the true spirit and scope of the inventive concept. Thus, to the maximum extent allowed by law, the scope of the inventive concept is to be determined by the broadest permissible interpretation of the following claims and their equivalents, and shall not be restricted or limited by the foregoing detailed description.

What is claimed is:

1. A display device comprising:
a first base substrate;
a first alignment layer disposed on the first base substrate;
a second base substrate;
a second alignment layer disposed on the second base substrate, the second alignment layer facing the first alignment layer;
a liquid crystal layer disposed between the first alignment layer and the second alignment layer, the liquid crystal layer comprising liquid crystal molecules;
electrodes applying an electric field into the liquid crystal layer,
wherein at least one of the first and second alignment layers comprises:
a main alignment layer;
a polar side chain connected to the main alignment layer, the polar side chain electrically interacting with the liquid crystal molecules according to the application of the electrical field; and
a non-polar side chain connected to the main alignment layer, the non-polar side chain configured to vertically align the liquid crystal molecules.

2. The display device of claim 1, wherein the liquid crystal molecules are a negative type, and the polar side chain is a positive type.

3. The display device of claim 2, wherein the polar side chain comprises:
a polar functional group; and
a connecting group connecting the main alignment layer to the polar functional group.

4. The display device of claim 3, wherein the polar functional group comprises at least one of materials having following Chemical Formula 1: 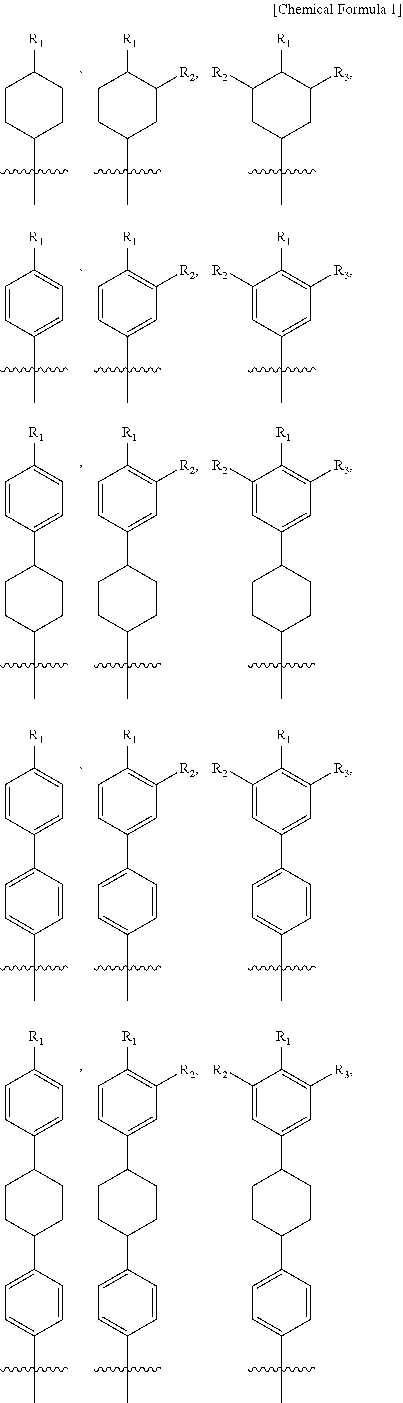 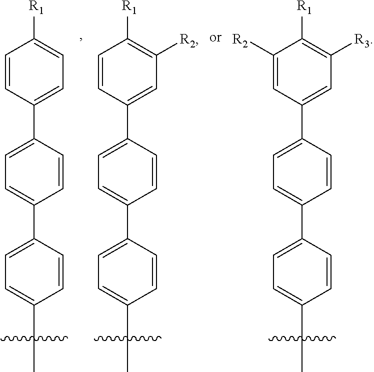
where R₁ denotes —F, —CN, —OCH₃, or —NO₂, R₂ denotes —F, —CN, —OCH₃, or —NO₂, and R₃ denotes —F, —CN, —OCH₃, or —NO₂.

5. The display device of claim 4, wherein the connecting group comprises an oxy-benzoate functional group.

6. The display device of claim 5, wherein the oxy-benzoate functional group comprises at least one of materials having following Chemical Formula 2:

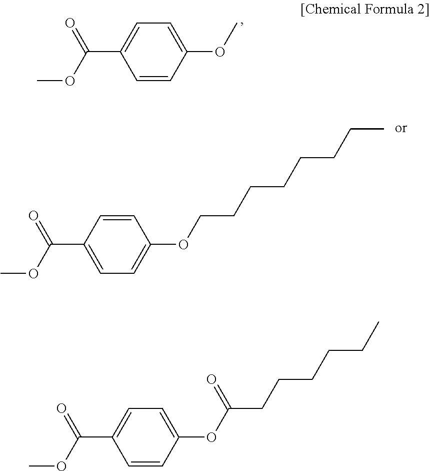

7. The display device of claim 3, wherein the non-polar side chain includes at least one of an alkoxy group including an aliphatic alkyl group having 1 to 25 carbon atoms, a cholesteric group, an alicyclic group including an aliphatic alkyl group having 1 to 10 carbon atoms, and an aromatic group including the aliphatic alkyl group having 1 to 10 carbon atoms.

8. The display device of claim 1, wherein the polar side chain has a molar ratio of about 10 mol % to about 90 mol % of the vertical alignment side chain.

9. The display device of claim 1, wherein the main alignment layer comprises a polyimide-based compound copolymer which comprises a dianhydride-based monomer and a diamine-based monomer.

10. The display device of claim 1, wherein the electrodes comprises a first electrode disposed on the first substrate and a second electrode disposed on the second substrate,
wherein the first electrode comprises a first domain divider for dividing the first electrode into a plurality of domains, and the second electrode comprises a second domain divider for dividing the second electrode into a plurality of domains.

11. The display device of claim 11, wherein, when viewed in plan view, a portion of the first domain divider and a portion of the second domain divider are alternately disposed.

12. The display device of claim 11, wherein each of the first and second domain dividers is a cutting portion or a protrusion.

13. The display device of claim 10, wherein the first electrode comprises first and second sub electrodes to which voltages different from each other are applied.
